(19) United States
(12) Patent Application Publication
(10) Pub. No.: US 2017/0366869 A1
(43) Pub. Date: Dec. 21, 2017

(54) DISCOVERY PROTOCOL SYSTEM

(71) Applicant: Sharp Kabushiki Kaisha, Sakai City, Osaka (JP)

(72) Inventor: SACHIN G. DESHPANDE, Camas, WA (US)

(21) Appl. No.: 15/540,382

(22) PCT Filed: Dec. 9, 2015
(86) PCT No.: PCT/JP2015/006144

§ 371 Date: Jun. 28, 2017

Related U.S. Application Data
(60) Provisional application No. 62/098,278, filed on Dec. 30, 2014.

(51) Int. Cl. H04N 21/6405; H04N 21/436; H04L 12/28

(52) U.S. Cl. CPC H04N 21/6405; H04N 21/43615; H04L 12/2807

(57) ABSTRACT

A system for discovering devices and for generating, providing and/or receiving services for second screen devices.

### TECHNICAL FIELD

The present disclosure relates generally to second screen devices and services.

### BACKGROUND ART

A video service is capable of sending audiovisual content to a receiving device. The receiving audiovisual device typically presents the content to the viewer, such as on a television device. In some cases, the viewer would like to use their mobile device, such as a mobile phone, to interact with the video content. However, how to most effectively interact with the audiovisual content on the receiving device using the mobile phone tends to be problematic due to synchronization issues. In one case the viewer may want to receive audiovisual content on a receiver such as a television device. At the same time the user may want to receive adjunct associated content on a second screen, e.g. a mobile device such as a smartphone or a tablet. The content received on the second screen device may be same as alternate content associated with the audiovisual content being received on the television. The user may typically like these two contents be presented on the primary and second screen device in a synchronized manner.

The foregoing and other objectives, features, and advantages of the invention will be more readily understood upon consideration of the following detailed description of the invention, taken in conjunction with the accompanying drawings.

### SUMMARY OF INVENTION

One embodiment of the present invention relates to:

A method for a primary device to advertise its presence on a network to a companion device comprising:
(a) advertising its presence using a multicast message; and
(b) sending said multicast message to a specific address and a specific port, wherein said multicast message have following fields:
(i) a first field including a primary device type signaled in a notification type header;
(ii) a second field including an identifier which uniquely identifies said primary device for said advertising;
(iii) a third field where a duration for which said primary device said multicast message is valid is be in a cache-control header; and
(iv) a fourth field including additional information about said primary device signaled in a location header.

### BRIEF DESCRIPTION OF DRAWINGS

FIG. 1 illustrates a video system.

FIG. 2 illustrates a primary device and a companion device system.

FIG. 3 illustrates another primary device and a companion device system.

FIG. 4 illustrates another primary device and a companion device system.

FIG. 5 illustrates another primary device and a companion device system.

FIG 6 illustrates another primary device and a companion device system.

FIG. 7 illustrates another primary device and a companion device system.

FIG. 8 illustrates another primary device and a companion device system.

FIG. 9 illustrates elements in a primary device response to a companion device search request.

FIG. 10 illustrates another primary device and a companion device system.

FIG. 11 illustrates another primary device and a companion device system.

FIG. 12 illustrates elements in a companion device response to a primary device search request.

FIG. 13 illustrates another primary device and a companion device system.

### DESCRIPTION OF EMBODIMENTS

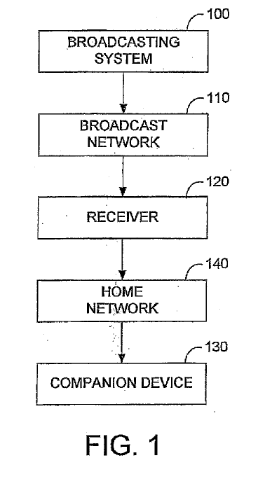

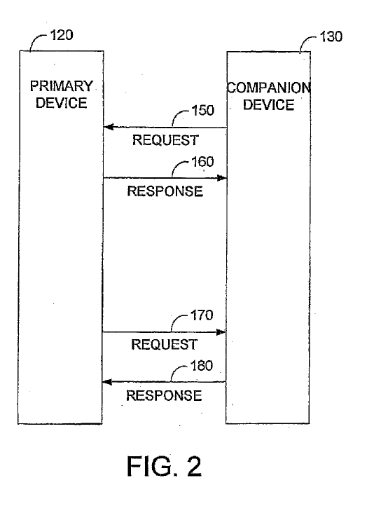

Referring to FIG. 1, a logical architecture of an audiovisual system is illustrated. The system includes a broadcasting system 100 that provides a source of audiovisual (video and/or audio and/or closed caption) content. The audiovisual content may be provided in any suitable manner and using suitable standards, such as for example, MPEG-2, MPEG-4 or ATSC. By way of example, the broadcasting system may be provided from a broadcasting antenna, a cable, a network based audiovisual source, a compact disk, a hard drive, a digital video disc, and/or an Internet based audiovisual source. The broadcasting system 100 may provide the content through any suitable broadcast network 110. A receiver 120 receives the audiovisual content together with any other data provided with the audiovisual content, such as digital data, data services, or otherwise. The receiver 120, generally referred to as a primary device, is preferably configured to receive the type of content being provided there to. The receiver may be, for example, a television, a laptop, a tablet, a phone, or any other device suitable to present the audiovisual content to a viewer. The receiver may be typically in a user's home. The receiver may likewise communicate with another display device 130, generally referred to as a companion device, through a home network 140. In another embodiment the companion device may communicate directly with an outside server to receive audiovisual and/or adjunct content. The home network is preferably a wireless or wired type network, such as for example, WiFi, Ethernet, 3GPP, Bluetooth, infra-red, HTTP. In some cases the home network may be a local area network. In some cases the primary and companion devices may be inside a user's home. In other cases, the home network may be an office environment. The companion device may include, for example, a mobile phone, a mobile tablet, a laptop, a computer, or other display device. In addition, the receiver may simultaneously communicate with a plurality of companion devices 130. Additionally one companion device may communicate simultaneously with multiple primary devices 120. In some embodiments the primary device may be called a first screen device. In some embodiments the companion device may be called a second screen device. The terms primary device and first screen device and receiver may be used interchangeably. The terms second companion device and second screen device may be used interchangeably. Referring to FIG. 2, it is often desirable that the primary device 120 is capable of providing information to the companion device 130. In addition, the companion device 130 may provide information to the primary device 120. Often, the companion device 130 makes a request 150 to the primary device 120, which in response thereto provides a response 160 to the companion device 130. In other cases, the primary device 120 makes a request 170 to the companion device 130, which in response thereto provides a response 180 to the primary device 120. This permits the primary device 120 to display content thereon, and the companion device 130 may likewise interact with the primary device 120. For example, it may be desirable that whatever is being presented on the primary device 120 is simultaneously being presented on the companion device 130, which may include for example, audio and/or video content. For example, it may be desirable to present a primary view of the video content on the primary device 120 and simultaneously present an alternative view of the same or similar scene of the video content on the companion device 130. For example, it may be desirable to present audiovisual content on the primary device 120 and simultaneously interact with an associated application that is started (or automatically started) on the companion device 130. In this case typically the content being presented on the primary device and the companion device should be synchronized. The synchronization refers to displaying the data corresponding to the same or approximately same time instance on the primary and the companion device.

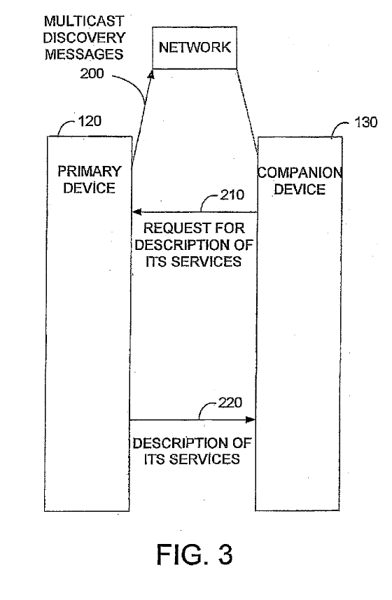

Referring to FIG. 3, by way of example, the user may have an ATSC compliant companion device 130 with an ATSC compliant application running thereon when an ATSC primary device 120 (e.g., a television) joins the network. This may occur, for example, when the receiver is turned on or its network interface is enabled. The ATSC primary device 120 may be capable of providing services for the companion device 130. The ATSC primary device 120 may multicast its discovery messages 200 to advertise its ATSC second screen support services. The ATSC compliant companion device 130 receives the multicast discovery messages and sends the ATSC primary device 120 a request for descriptions of its services 210. The ATSC primary device 120 responds to this request with a description of its services 220. The ATSC compliant companion device 130 uses the information provided in the descriptions to access the appropriate services and provide an interactive experience synchronized with the programming on the primary device 120.

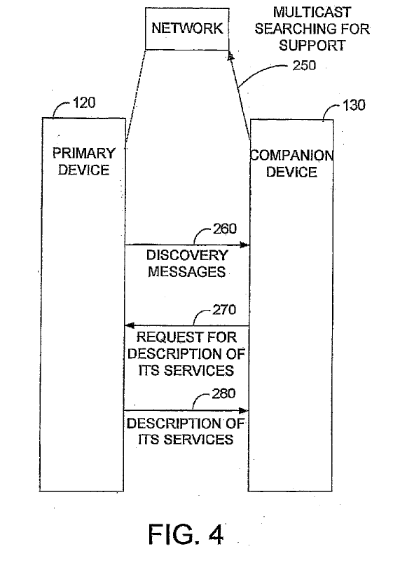

Referring to FIG. 4, by way of example, the user may not have an ATSC compliant companion device 130 with an ATSC compliant application running thereon when the ATSC primary device 120 (e.g., television) joins the network. The audiovisual content being viewed on the ATSC compliant primary device 120 may enter a program segment that offers companion device 130 support. This may occur, for example, when the receiver is turned on or its network interface is enabled, or when a channel change goes from a channel that does not offer the companion device 130 with another that does offer support for the companion device 130, or when the channel being viewed goes from a program segment that does not offer support for the companion device 130 to a segment that does offer support for the companion device 130. This viewing change causes the ATSC primary device 120 to inform the viewer in some manner that companion device 130 support is available. For example, a small icon may be presented in the corner of the primary device 120. If the viewer decides to take advantage of the second screen support and activate an ATSC compliant application on the companion device 130, then the companion device 130 may multicast a message 250 searching for devices that offer ATSC companion device 130 support or service. The ATSC primary device 120 may respond to this message with its discovery messages 260. When the companion device 130 receives the discovery messages, it sends the ATSC primary device 120 receiver a request for descriptions of its services 270. The ATSC primary device 120 responds with description of its services 280. The companion device 130 uses the information given in the descriptions to access the appropriate services and provide an interactive experience synchronized with the audiovisual content.

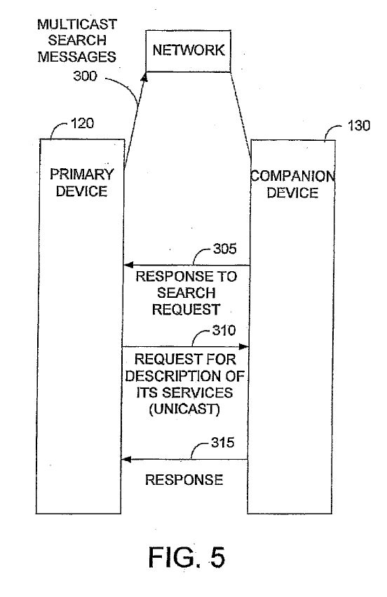

Referring to FIG. 5, by way of example, the viewer has an ATSC compliant companion device application running when the ATSC primary device joins the network (e.g., when the primary device is turned on or the network interface is enabled). The primary device 120 desires to discover one or more companion devices 130 on the network. The primary device 120 joins the network and multicasts it search messages 300 seeking companion devices 130. The companion device 130 running an ATSC application receives the multicast search message and in response sends the primary device 120 a response indicating its presence 305. On receiving this response the primary device 120 may send a request 310 for the description of services that companion device offers to primary device. The message 310 may be sent via a unicast technique, rather than a multicast technique. On receiving the message 310 the companion device responds with a description of its services by sending a message 315 to the primary device. The primary device 120 receives the message 315 and uses the information given in the service descriptions to access the appropriate services and to understand the capabilities of the companion device 130.

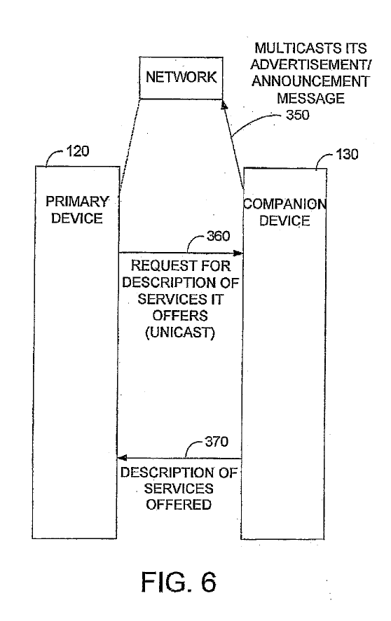

Referring to FIG. 6, by way of example, a new ATSC companion device 130 joins the network or an ATSC application is started on a companion device 130. The primary device 120 is already on the network. The companion device 130 multicasts its advertisement/announcement message 350 that announces the companion device 130 and its available services. The primary device 120 receives the multicast advertisement message from the companion device 130 via network and sends the companion device 130 a request for descriptions of the services it offers 360. The message may be sent via unicast, rather than multicast. The companion device receives the message and responds with a description of the services it offers 370 to the primary device 120. The primary device 120 uses the information given in the service descriptions to access the appropriate services and to understand the capabilities of the companion device.

As illustrated in FIGS. 3-6, the household may have more than one companion device on the home network and the household may have more than one primary device on the network. In this case each ATSC companion device would receive lookup messages from multiple different primary devices via network. Also multiple primary devices will receive announcement messages from multiple companion devices via network.

As noted above, in some environments, there may be more than one primary device 120, especially when using the home network. In this case, the companion device 130 may receive discovery messages from the multiple primary devices 120 via network. If that happens the companion device 130 may ask the user which of the primary devices 120 to interact with.

A typical application on the companion device 130 may operate as follows. A control point or service on the companion device 130 subscribes to a packaged apps service on the primary device 120. A packaged app may be an application on the device offering service. A viewer starts the packaged app on the primary device 120 The packaged app makes the name of application on the companion device 130 and the URL of the application on the companion device 130 available to the packaged app service. The control point on the companion device 130 receives the companion application name and URL. The control point sets a marker on the companion device 130 indicating that viewer action is needed. The viewer reviews the companion application name and selects it. The control point launches the indicated application on the companion device 130 as indicated by ATSC Candidate Standard: Interactive Services Standard (A/105:2014), Apr. 24, 2014 (513-2-389r7), incorporated by reference herein in its entirety.

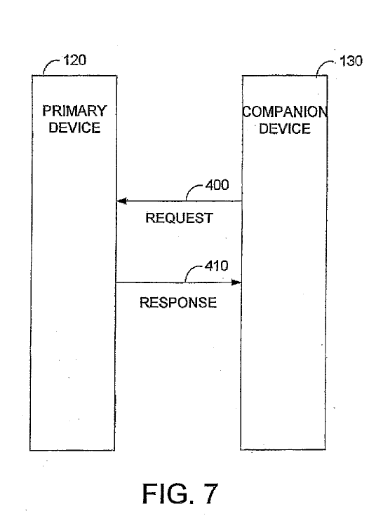

Referring to FIG. 7, it is desirable for the companion device 130 to request information from the primary device 120 about the current audiovisual content being presented on the primary device. While the companion device 130 may make a request to subscribe to the receive the information about content being presented the primary device 120 which provides a response with an ID for the content, and then make a request for the content based upon the ID, this is a cumbersome process. In addition, in the event that the content being displayed on the primary device 120 changes, then the ID provided by the companion device 130 that was previously received will refer to different content than that currently being presented on the primary device causing a disrupted experience for the viewer using the companion device 130. To alleviate the concern about receiving a response that does not correspond to the currently displayed audiovisual content, the companion device 130 preferably makes a single request 400 to the primary device 120 for information about the currently running service, program and/or show, and/or segment without having to provide an identification of the currently running service, show, and/or segment. The primary device 120, in response to receiving the request 400, provides a response 410 with the desirable information. The desirable information may include, for example, an electronic service guide type information about the content currently being presented on the primary device

For example the companion device 130 may make a request to the primary device 120 to receive current service information. This may be invoked at any time when needed by the application. The input parameters for this request may include one or more of the following:
Companion Device ID
Companion Device Application ID
Companion Device Application Version
Current information requested may include one or more of following:
   Request for current show information (e.g., electronic service guide information for the current show being presented on the primary device);
   Request for currently available components for the current show being presented on the primary device (e.g., video, audio, closed captioning, main camera view, alternative camera view, etc. for the content being presented on the primary device);
   Request for currently available files and/or non-real-time content for the current show being presented on the primary device;
Optionally the request may include a filtering criterion which may be used to limit the amount of information being requested in response thereto.
An example of the filtering criterion may be e.g., standard definition video only, high definition video or ultra high definition video, black/white video, color video, 5.1 channel audio, or stereo audio etc.

For example the primary device 120 may send a response to the companion device 130 after receiving the above request. This may preferably be sent upon receiving a service information request. The response parameters 410 may include one or more of the following:
Primary device ID
Requested information about the current show may include one or more of following:
   Current show information (e.g., electronic service guide);
   Information about ccurrently available components for the current show (e.g., video, audio, closed captioning, main camera view, alternative camera view);
   Currently available files and/or non-real-time content for the current show.

As previously described, a protocol may be used for the discovery of the primary device from the companion device and for the discovery of companion device from the primary device. The primary device (PD) may be discoverable from companion device (CD) by advertising and providing services which can be utilized by companion device. The companion (second screen) device may be discoverable from primary (first screen) device by advertising and providing services and description of its capabilities which can be utilized by the primary (first screen) device.

As previously described, both the primary device and the companion device are capable of sending multicast discovery messages searching and/or advertising their presence and ATSC service support. In some embodiments, there may be more than one PD and/or its application on the home network, so a CD and/or its application may receive discovery messages from multiple PDs. In that case, the CD and/or its application can ask the user which one(s) to interact with (displaying information from the discovery messages to help the user decide).

Different protocols may be used for the discovery of the PD from the CD and for the discovery of the CD from the PD. For example, UPnP (i.e., Universal Plug and Play) is an architecture for pervasive peer-to-peer network connectivity of intelligent appliances, and devices of all form factors. UPnP basic device architecture may be used for discovery, description, control, eventing and presentation. For example, Simple Service Discovery Protocol (SSDP) may be used for the discovery of the PD from the CD and for discovery of the CD from the PD. In one embodiment, UPnP's device and service discovery phase which uses the SSDP protocol may be used for the discovery of the PD from the CD and for discovery of the CD from the PD. For example, Simple Service Discovery Protocol (SSDP) provides a mechanism for network clients, with little or no static configuration, to discover network services. SSDP accomplishes this discovery by providing for multicast discovery support as well as server based notification and discovery routing.

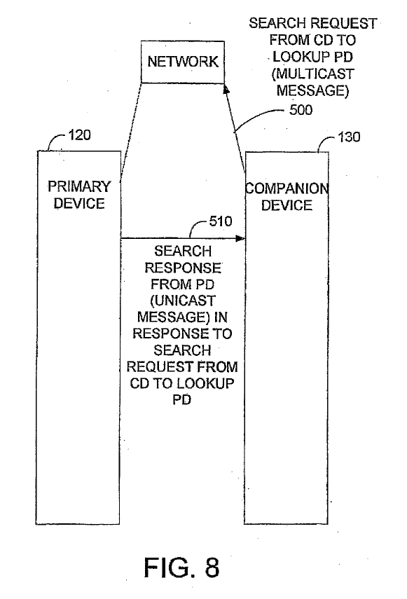

Referring to FIG. 8, an example of a companion device application SSDP based search request message for looking up a primary device using a multicast technique 500 is illustrated. In one embodiment, a CD may search for a primary device on the network to get connected to it and to consume service(s) offered by it. In one embodiment, this search process may be performed based upon the following:

First, when one or more of the following conditions are true a CD may send a multicast search request to search for PD(s) on the network:
(1) when a CD joins the network;
(2) when a CD application starts on the companion device;
(3) when a search/discovery scan is initiated by the CD application. For example, this may be done based on a user requesting search for a primary device from within a CD or CD application;
(4) anytime a CD sends multicast request for device type/service type of the PD.

In some embodiments, the CD may periodically initiate discovery scans to find the most recent information regarding available PD(s) on the network.

Second, the multicast search request may be sent to a specific address and port on the network. In one embodiment, the multicast search request may be sent to the address 239.255.255.250 and port 1900, i.e. (239.255.255.250:1900). In another embodiment the multicast search request may be sent to some other multicast address e.g. 239.255.255.248 and some other port, e.g. 1888 i.e. (239.255.255.248:1888).

By way of example, the multicast search request from the CD may be a M-SEARCH request.

Third, the multicast search request may be sent to search for a primary device type and/or primary device service type. By way of example, specific names may be pre-defined for the primary device and/or the service type. For example following names may be pre-defined:
(1) urn:schemas-atsc.org:device:primaryDevice:1.0, where the string “schemas-atsc.org” together with the string “primaryDevice” uniquely identifies this search for ATSC's primary device and 1.0 indicates a version number. Other such string names could be used instead. For example, instead the string uri.atsc.org.prinnaryDevice.1.0 may be used for searching for identifying an ATSC 3.0 primary device.
(2) urn:schemas-atsc.org:device:primaryDeviceService:1.0, where the string “schemas-atsc.org” together with the string “primaryDeviceService” uniquely identifies this search for ATSC's primary device service and 1.0 indicates a version number. Other such string names could be used instead.
For example, instead the string uri.atsc.org.primaryService.1.0 may be used for searching and identifying an ATSC 3.0 primary device service.
In some cases a device and service are distinguished from each other in that a device of a certain device type (e.g. An ATSC primary device) may be searched first and that device may provide one or more type of services.

In another embodiment the companion device may send the multicast search request with “ssdp:all” as the string—requesting a response from each device on the network which understands the SSDP protocol.

In one embodiment the primary device type and/or primary device service type string may be sent in the “ST” header of the multicast search request.

Fourth, the multicast search request from the CD may be as follows:
M-SEARCH * HTTP/1.1
HOST: 239.255.255.250:1900
MAN: “ssdp:discover”
MX: <max response delay in seconds>
ST: urn:schemas-atsc.org:device:primaryDeviceService:1.0

The max response delay in seconds indicates that a primary device should send a response within a random duration between 0 to <max response delay in seconds> value.

In one embodiment the multicast search request (M-SEARCH) from the CD may be transmitted more than once as the request is sent on UDP which provides unreliably delivery.

Referring again to FIG. 8, when a PD receives a multicast search message from the CD which is looking for a PD corresponding to the primary device and/or primary device service type corresponding to this PD 500 it responds to the CD with a unicast search response to the CD search message 510. In one embodiment, this process may be performed based upon the following:

First, when an ATSC primary device receives a multicast search message (M-SEARCH) message described above it may send a unicast search response with a random duration between 0 to <max response delay in seconds>seconds, where <max response delay in seconds> is found in the MX header of the M-SEARCH request from the CD. This allows load balancing and avoids a storm of responses on the network to a M-SEARCH request. In some embodiments, the CD may periodically initiate discovery scans to find the most recent information regarding available PD(s) on the network.

Second, the unicast response to M-SEARCH from a primary device and/or primary device service may be as shown below:
HTTP/1.1 200 OK
CACHE-CONTROL: max-age=<advertisement validation duration in seconds>
DATE: when response was generated
EXT:
LOCATION: <URL for primary device and/or primary device service>
SERVER: <Primary device ID/Version>
ST: urn:schemas-atsc.org:device:primaryDeviceService:1.0
USN: <PD advertisement UUID>

Third, the <PD advertisement UUID> may be a string of the form:
(1) uuid:<device uuid>:urn:schemas-atsc.org:device:primaryDevice:1.0 where the string “schemas-atsc.org” together with the string “primaryDevice” uniquely identifies this as an ATSC's primary device and 1.0 indicates a version number. Other such string names could be used instead. For example, instead the string uri.atsc.org.prinnaryDevice.1.0 may be used for identifying an ATSC 3.0 primary device.
(2) uuid:<device uuid>:urn:schemas-atsc.org:device:primaryDeviceService:1.0 where the string “schemas-atsc.org” together with the string “primaryDeviceService” uniquely identifies this as an ATSC's primary device service and 1.0 indicates a version number. Other such string names could be used instead. For example, instead the string uri.atsc.org.primaryService.1.0 may be used for identifying an ATSC 3.0 primary device service.

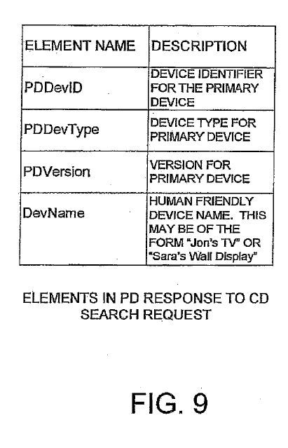

Fourth, one or more elements and/or parameters may be sent in the PD response to a M-SEARCH request. These may be sent either in the headers or in the message body. When sent in the header the element name may be used as header name. When sent in the body a XML element of the same name or a JSON data may be defined. The elements/parameters may be as shown in FIG. 9.

Alternatively, the parameters defined in FIG. 9 may be listed as follows.
(1) PD Device ID;
(2) PD Device type (ATSC 3.0 TV Set) and version (of ATSC 3.0 support);
(3) User-friendly name of PD (e.g., Living Room TV);
(4) PD services/support operations supported.

Additionally one or more of the following parameters providing more information about the primary device may be sent in the unicast response to the multicast search message from companion device M-SEARCH.
(1) Manufacturer (e.g., Sharp);
(2) Model (e.g., LE-1000);
(3) OS (e.g., Android 4.1.2);
(4) Supported video formats by primary device;
(5) Display capabilities (e.g., screen size, resolution, aspect ratio, 3D capable);
(6) Internet access capabilities (speed, state);
(7) Storage capabilities (total space, available space);
(8) Content rights permissions (e.g., user is a valid subscriber to a given service);
(9) User profile data;
(10) Known companion device(s);
(11) Supported connection mechanisms (to companion device(s));
(12) Connection type/speed to the companion device(s).

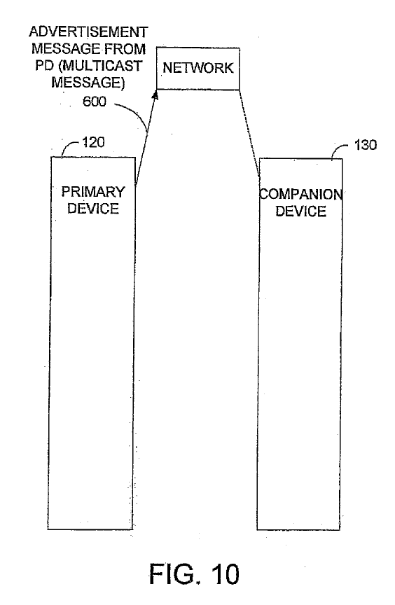

Referring to FIG. 10, the primary device may advertise its presence on the network 600 to help it to be discovered by companion device(s) on the network. In one embodiment, this process may be performed based upon the following:

First, when a primary device joins the network it may multicast a messages to advertise itself as a primary device and/or primary device service type root device, any embedded devices, and any services.

Second, the multicast advertisement message from the PD may be sent to a specific address and port. In one embodiment, the multicast advertisement message from the PD may be sent to the address 239.255.255.250 and port 1900 i.e. (239.255.255.250:1900). In another embodiment the multicast advertisement message from the PD may be sent to some other multicast address e.g. 239.255.255.248 and some other port, e.g. 1888 i.e. (239.255.255.248:1888).

Third, the advertisement message may consist of one or more of the following fields:
(1) Primary device type and/or primary device service type signaled in a Notification Type (NT) header indicating unique primary device and service type provided. In one embodiment, specific names may be pre-defined for primary device and/or service type and may be signaled in the NT header. For example following names may be pre-defined:
   (a) urn:schemas-atsc.org:device:primaryDevice:1.0 where the string “schemas-atsc.org” together with the string “primaryDevice” uniquely identifies this as ATSC's primary device and 1.0 indicates a version number. Other such string names could be used instead. For example, instead the string uri.atsc.org.primaryDevice.1.0 may be used for notifying and for identifying an ATSC 3.0 primary device.
   (b) urn:schemas-atsc.org:device:primaryDeviceService:1.0 where the string “schemas-atsc.org” together with the string “primaryDeviceService” uniquely identifies this as an ATSC's primary device service and 1.0 indicates a version number. Other such string names could be used instead. For example, instead of above the string uri.atsc.org.primaryService.1.0 may be used for notifying and for identifying an ATSC 3.0 primary device service.
(2) An identifier which uniquely identifies this primary device and/or primary device service for the advertisement may be signaled in an USN (Unique Service Name) header. In one embodiment, the unique identifier in the advertisement may be a string of the form:
   (a) uuid:<device uuid>:urn:schemas-atsc.org:device:primaryDevice:1.0 where the string “schemas-atsc.org” together with the string “primaryDevice” uniquely identifies this as an ATSC's primary device and 1.0 indicates a version number. Other such string names could be used instead. For example, instead the string uri.atsc.org.primaryDevice.1.0 may be used for notifying and for identifying an ATSC 3.0 primary device.
   (b) uuid:<device uuid>:urn:schemas-atsc.org:device:primaryDeviceService:1.0 where the string “schemas-atsc.org” together with the string “primaryDeviceService” uniquely identifies this as an ATSC's primary device service and 1.0 indicates a version number. Other such string names could be used instead. For example, instead the string uri.atsc.org.primaryService.1.0 may be used for notifying and for identifying an ATSC 3.0 primary device service.
(3) Duration for which the PD advertisement message is valid may be signaled in a CACHE-CONTROL header. In one embodiment, the companion device can only assume that the primary device and/or the primary device service type indicated in the NT header is only available for the duration specified in the CACHE-CONTROL header. In one embodiment, it may be required that the value indicated for the availability duration in the CACHE-CONTROL header is greater than or equal to some number of seconds. For example, it may be required that the value in the CACHE-CONTROL header is greater than or equal to 30 minutes or 60 minutes.
(4) Additional information about the primary device and/or primary device service may be signaled in the LOCATION header.

Fourth, the multicast advertisement message from a primary device and/or primary device service may be follows:
NOTIFY * HTTP/1.1
HOST: 239.255.255.250:1900
CACHE-CONTROL: max-age=<advertisement validity duration in seconds>
LOCATION: <URL for primary device and/or primary device service>
NT: urn:schemas-atsc.org:device:primaryDeviceService:1.0
NTS: ssdp:alive
SERVER: <Primary device ID/Version>
USN: <PD advertisement UUID>

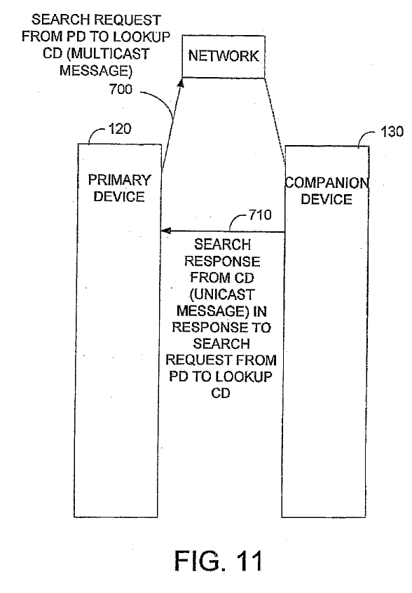

Referring to FIG. 11, the primary device may search for a companion device on the network 700. In one embodiment, this process may be performed based upon the following:

First, when one or more of the following conditions are true a PD send a multicast search request to search for PD(s) on the network:
(1) when PD joins the network;
(2) when PD starts;
(3) when a search/discovery scan is initiated within on the PD. For example, this may be done based on a user requesting search for a companion device from within a PD or a PD application;
(4) anytime PD sends multicast request for device type/service type of the CD.

In some embodiments, PD may periodically initiate discovery scans to find most recent information regarding available CD(s) on the network.

Second, the multicast search request may be sent to a specific address and port. In one embodiment, the multicast search request may be sent to the address 239.255.255.250 and port 1900 i.e. (239.255.255.250:1900). In one embodiment, the multicast search request from the PD may be a M-SEARCH request. In another embodiment the multicast search request may be sent to some other multicast address e.g. 239.255.255.248 and some other port, e.g. 1888 i.e. (239.255.255.248:1888).

Third, the multicast search request may be sent to search for a companion device type and/or companion device service type. In one embodiment, specific names may be pre-defined for companion device and/or service type. For example following names may be pre-defined:
(1) urn:schemas-atsc.org:device:companionDevice:1.0 where the string “schemas-atsc.org” together with the string “companionDevice” uniquely identifies this search for an ATSC's companion device and 1.0 indicates a version number. Other such string names could be used instead. For example, instead the string uri.atsc.org.companionDevice.1.0 may be used for searching and identifying an ATSC 3.0 companion device.
(2) urn:schemas-atsc.org:device:companionDeviceService:1.0 where the string “schemas-atsc.org” together with the string “companionDeviceService” uniquely identifies this search for an ATSC's companion device service and 1.0 indicates a version number. Other such string names could be used instead. For example, instead the string uri.atsc.org.companionService.1.0 may be used for searching for an ATSC 3.0 companion device service.

In another embodiment, the primary device may send the multicast search request with “ssdp:all” as the string—requesting a response from each device on the network which understands the SSDP protocol.

In one embodiment the companion device type and/or companion device service type string may be sent in the “ST” header of the multicast search request.

Fourth, the multicast search request from PD may be as follows:
M-SEARCH * HTTP/1.1
HOST: 239.255.255.250:1900
MAN: “ssdp:discover”
MX: <max response delay in seconds>
ST: urn:schemas-atsc.org:device:companionDeviceService:1.0

The max response delay in seconds indicates that a companion device should send a response within a random duration between 0 to <max response delay in seconds>.

Fifth, the multicast search request (M-SEARCH) from the PD may be transmitted more than once as the request is sent on UDP.

Referring again to FIG. 11, when a CD receives a multicast search message from the PD who is looking for a CD corresponding to the companion device and/or companion device service type corresponding to this CD, it responds to the PD with a unicast response to this PD search message 710. In one embodiment, this process may be performed based upon the following:

First, when an ATSC companion device receives a multicast search message (M-SEARCH) message from a PD it may send a unicast response within a random duration between 0 to <max response delay in seconds>seconds, where <max response delay in seconds> is found in the MX header of the M-SEARCH request from the PD. This allows load balancing and avoids storm of responses on the network to a M-SEARCH request. In some embodiments, the PD may periodically initiate discovery scans to find the most recent information regarding available CD(s) on the network.

Second, the unicast response to M-SEARCH from a companion device and/or companion device service may be as follows:
HTTP/1.1 200 OK
CACHE-CONTROL: max-age=<advertisement validation duration in seconds>
DATE: <when response was generated>
EXT:
LOCATION: <URL for device/service description for companion device>
SERVER: <Companion device ID/Version>
ST: urn:schemas-atsc.org:device:companionDeviceService:1.0
USN: <advertisement UUID>

Third, the <advertisement UUID> may be a string of the form:
(1) uuid:<device uuid>:urn:schemas-atsc.org:device:companionDevice:1.0 where the string “schemas-atsc.org” together with the string “companionDevice” uniquely identifies this as an ATSC's companion device and 1.0 indicates a version number. Other such string names could be used instead. For example, instead the string uri.atsc.org.companionDevice.1.0 may be used for identifying an ATSC 3.0 companion device.
(2) uuid:<device uuid>:urn:schemas-atsc.org:device:companionDeviceService:1.0 where the string “schemas-atsc.org” together with the string “companionDeviceService” uniquely identifies this as an ATSC's companion device service and 1.0 indicates a version number. Other such string names could be used instead. For example, instead the string uri.atsc.org.companionService.1.0 may be used for identifying an ATSC 3.0 companion device service.

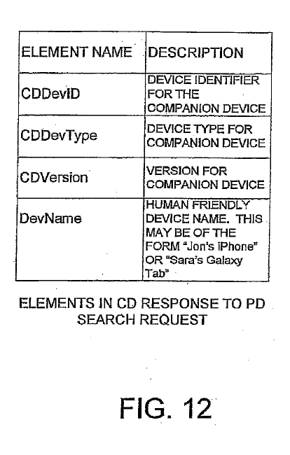

Third, one or more elements and/or parameters may be sent in the CD response to a M-SEARCH request. These may be sent either in the headers or in the message body. When sent in the header the element name may be used as header name. When sent in the body a XML element of the same name or a JSON data may be defined. The elements/parameters may be as shown in FIG. 12.

Alternatively the parameters of FIG. 12 may be listed as follows:
(1) CD Device ID;
(2) CD Device type (ATSC 3.0 smart phone) and version (of ATSC 3.0 support);
(3) User-friendly name of CD (e.g., Jane's iPad);
(4) CD services/support operations supported.

Additionally one or more of the following parameters providing more information about the companion device may be sent in the unicast response to the multicast search message from companion device M-SEARCH.
(1) Unique ID for the companion device;
(2) User-friendly name (e.g., Jane's iPad);
(3) User-friendly Device Type (e.g., “Smartphone”);
(4) Manufacturer (e.g., Apple);
(5) Model (e.g., iPhone 6);
(6) OS (e.g., iOS 8.0.2);
(7) Input capabilities (e.g., touch screen, keyboard);
(8) Supported video formats by primary device;
(9) Display capabilities (e.g., screen size, resolution, aspect ratio, 3D-capable);
(10) Internet access capabilities (speed, state);
(11) Storage capabilities (total space, available space);
(12) Content rights permissions (e.g., user is a valid subscriber to a given service);
(13) User profile data;
(14) Known primary device(s);
(15) Supported connection mechanisms (to primary device(s));
(16) Connection type/speed/state to the primary device.

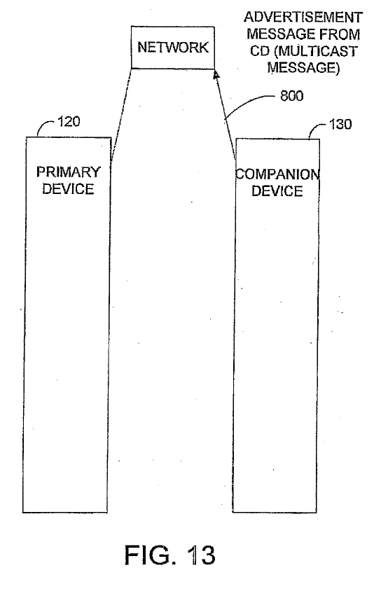

Referring to FIG. 13, the companion device may advertise its presence on the network to assist it to be discovered by the primary device(s) on the network 800. In one embodiment, this process may be performed based upon the following:

First, when a companion device joins the network it may multicast a messages to advertise itself as a companion device and/or companion device service type root device, any embedded devices, and any services.

Second, the multicast advertisement message from the CD may be sent to a specific address and port. In one embodiment, the multicast advertisement message from CD may be sent to the address 239.255.255.250 and port 1900 i.e. (239.255.255.250:1900). In another embodiment the multicast advertisement message from the CD may be sent to some other multicast address e.g. 239.255.255.248 and some other port, e.g. 1888 i.e. (239.255.255.248:1888).

Third, the advertisement message may include of one or more of the following fields:
(1) Companion device type and/or companion device service type signaled in a Notification Type (NT) header indicating unique companion device and service type provided. In one embodiment specific names may be pre-defined for companion device and/or service type and may be signaled in the NT header. For example following names may be pre-defined.
   (a) urn:schemas-atsc.org:device:companionDevice:1.0 where the string “schemas-atsc.org” together with the string “companionDevice” uniquely identifies this as an ATSC's companion device and 1.0 indicates a version number. Other such string names could be used instead. For example, instead the string uri.atsc.org.companionDevice.1.0 may be used for notifying and for identifying an ATSC 3.0 companion device.
   (b) urn:schemas-atsc.org:device:companionDeviceService:1.0 where the string “schemas-atsc.org” together with the string “companionDeviceService” uniquely identifies this as an ATSC's companion device service and 1.0 indicates a version number. Other such string names could be used instead. For example, instead the string uri.atsc.org.companionService.1.0 may be used for notifying and for identifying an ATSC 3.0 companion device service.
(2) An identifier which uniquely identifies this companion device and/or companion device service for the advertisement may be signaled in an USN (Unique Service Name) header. In one embodiment the unique identifier in the advertisement may be a string of the form:
   (a) uuid:<device uuid>:urn:schemas-atsc.org:device:companionDevice:1.0 where the string “schemas-atsc.org” together with the string “ companionDevice” uniquely identifies this as an ATSC's companion device and 1.0 indicates a version number. Other such string names could be used instead. For example, instead the string uri.atsc.org.companionDevice.1.0 may be used for notifying and for identifying an ATSC 3.0 companion device.
   (b) uuid:<device uuid>:urn:schemas-atsc.org:device:companionDeviceService:1.0 where the string “schemas-atsc.org” together with the string “companionDeviceService” uniquely identifies this as an ATSC's companion device service and 1.0 indicates a version number. Other such string names could be used instead. For example, instead the string uri.atsc.org.companionService.1.0 may be used for notifying and for identifying an ATSC 3.0 companion device service.
(3) Duration for which the CD advertisement message is valid may be signaled in a CACHE-CONTROL header. In one embodiment the primary device can only assume that companion device and/or companion device service type indicated in the NT header is only available for the duration specified in the CACHE-CONTROL header. In one embodiment it may be required that the value indicated for the availability duration in the CACHE-CONTROL header is greater than or equal to some number of seconds. For example it may be required that the value in the CACHE-CONTROL header is greater than or equal to 30 minutes or 60 minutes.
(4) Additional information about the companion device and/or companion device service may be signaled in the LOCATION header.

Fourth, the multicast advertisement message from a companion device and/or companion device service may be as follows:
NOTIFY * HTTP/1.1
HOST: 239.255.255.250:1900
CACHE-CONTROL: max-age=<advertisement validity duration in seconds>
LOCATION: <URL for companion device and/or companion device service>
NT: urn:schemas-atsc.org:device:companionDeviceService:1.0
NTS: ssdp:alive
SERVER: <Companion device ID/Version>
USN: <CD advertisement UUID>

In another embodiment instead of SSDP a DNS-Based Service Discovery (DNS-SD) may be used for discovery of the PD from the CD and for discovery of the CD from the PD. DNS-SD describes a convention for naming and structuring DNS resource records. Given a type of service that a client is looking for, and a domain in which the client is looking for that service, this convention allows clients to discover a list of named instances of that desired service, using only standard DNS queries. In this case, a named service may be constructed for the PD and the CD acting as a client can use the DNS-SD to discover the PD with the named service. Similarly, a named service could be constructed for the CD and the PD acting as a client can use the DNS-SD to discover the CD with the named service.

In another embodiment, mDNS-DNS queries via IP Multicast (mDNS) may be used for discovery of the PD from the CD and for discovery of the CD from the PD. mDNS provides the capability to look up host names and similar DNS resource record data types, in the absence of a conventional managed DNS server. This may be by requiring no change to the structure of DNS messages, and no new operation codes, response codes, or resource record types.

In yet another embodiment, Rendezvous may be used for discovery of the PD from the CD and for discovery of the CD from the PD. Rendezvous may enable automatic discovery of computers, devices, and services on IP networks. Rendezvous may also be referred to as Zero Configuration networking.

It is to be understood that the claims are not limited to the precise configuration and components illustrated above. Various modifications, changes and variations may be made in the arrangement, operation and details of the systems, methods, and apparatus described herein without departing from the scope of the claims.

1.A method for a primary device to advertise its presence on a network to a companion device comprising:
(a) advertising its presence using a multicast message; and
(b) sending said multicast message to a specific address and a specific port, wherein
said multicast message have following fields:
(i) a first field including a primary device type signaled in a notification type header;
(ii) a second field including an identifier which uniquely identifies said primary device for said advertising;
(iii) a third field where a duration for which said primary device said multicast message is valid is be in a cache-control header; and
(iv) a fourth field including additional information about said primary device signaled in a location header.

2. The method of claim 1 wherein said presence is as a primary device.

3. The method of claim 1 wherein said specific address is 239. 255.255.250.

4. The method of claim 1 wherein said specific port is 1900.

5. The method of claim 1 wherein said specific address and said specific port is 239.255.255.250:1900.

6. The method of claim 1 wherein said primary device type is urn:schemas-atsc.org:device:primaryDevice:1.0.

7. The method of claim 1 wherein said identifier is signaled in a unique service name header.

8. The method of claim 1 wherein said identifier is of a form uuid:<device uuid>:urn: schemas-atsc.org:device:primaryDevice:1.0.

9. The method of claim 1 wherein said multicast message includes the following said fields:
NOTIFY * HTTP/1.1
HOST: 239.255.255.250:1900
CACHE-CONTROL: max-age=<advertisement validity duration in seconds>
LOCATION: <URL for primary device>
NT: urn:schemas-atsc.org:device:primaryDevice:1.0
NTS: ssdp:alive
SERVER: <Primary device ID/Version>
USN: uuid:<device uuid>:urn: schemas-atsc.org:device:primaryDevice:1.0.

10. The method of claim 1 further comprising receiving another message from said companion device based on said location header and said notification type header.
